(19) United States
(12) Patent Application Publication
(10) Pub. No.: US 2016/0054826 A1
(43) Pub. Date: Feb. 25, 2016

(54) Ultrasound-Based Force Sensing

(71) Applicant: Apple Inc., Cupertino, CA (US)

(72) Inventors: Brian Q. Huppi, Cupertino, CA (US); Martin P. Grunthaner, Cupertino, CA (US); John G. Elias, Cupertino, CA (US); Sinan Filiz, Cupertino, CA (US); Steven P. Hotelling, Cupertino, CA (US)

(21) Appl. No.: 14/727,839

(22) Filed: Jun. 1, 2015

Related U.S. Application Data
(63) Continuation of application No. 14/417,331, filed on Jan. 26, 2015, now abandoned.
(60) Provisional application No. 61/676,293, filed on Jul. 26, 2012.

(51) Int. Cl. G06F 3/043; G06F 3/041

(52) U.S. Cl. CPC G06F 3/043; G06F 3/0414

(57) ABSTRACT

A force sensing device for computer or electronic devices. The force sensing device is configured to determine an amount of force applied, and changes in amounts of force applied, by the user when contacting a device, such as a touch device, and which can be incorporated into devices using touch recognition, touch elements of a graphical user interface, and touch input or manipulation in an application program. Additionally, the force sensing device may determine an amount of force applied, and changes in amounts of force applied, by the user when contacting a device, such as a touch device, and in response thereto, provide additional functions available to a user of a touch device, track pad, or the like.

### CROSS REFERENCE TO RELATED APPLICATIONS

This application is a continuation of U.S. patent application Ser. No. 14/417,331, filed Jan. 26, 2015, and entitled Ultrasound-Based Force Sensing,” which application is a 35 U.S.C. §371 application of PCT/US2013/032555, which was filed on Mar. 15, 2013, and entitled “Force Detection by an Ultrasound Sensor,” and further claims the benefit under 35 U.S.C. §119(e) to U.S. provisional application No. 61/676,293, filed Jul. 26, 2012, and entitled, “Ultrasound-Based Force Sensing,” all of which are incorporated by reference as if fully disclosed herein.

### BACKGROUND

1. Field of the Disclosure

This application generally relates to force sensing using ultrasound.

2. Background of the Disclosure

Touch devices generally provide for identification of positions where the user touches the device, including movement, gestures, and other effects of position detection. For a first example, touch devices can provide information to a computing system regarding user interaction with a graphical user interface (GUI), such as pointing to elements, reorienting or repositioning those elements, editing or typing, and other GUI features. For a second example, touch devices can provide information to a computing system suitable for a user to interact with an application program, such as relating to input or manipulation of animation, photographs, pictures, slide presentations, sound, text, other audiovisual elements, and otherwise.

It sometimes occurs that, when interfacing with a GUI, or with an application program, it would be advantageous for the user to be able to indicate an amount of force applied when manipulating, moving, pointing to, touching, or otherwise interacting with, a touch device. For example, it might be advantageous for the user to be able to manipulate a screen element or other object in a first way with a relatively lighter touch, or in a second way with a relatively more forceful or sharper touch. In one such case, it might be advantageous if the user could move a screen element or other object with a relatively lighter touch, while the user could alternatively invoke or select that same screen element or other object with a relatively more forceful or sharper touch.

Each of these examples, as well as other possible considerations, can cause one or more difficulties for the touch device, at least in that inability to determine an amount of force applied by the user when contacting the touch device might cause a GUI or an application program to be unable to provide functions that would be advantageous. When such functions are called for, inability to provide those functions may subject the touch device to lesser capabilities, to the possible document of the effectiveness and value of the touch device.

### BRIEF SUMMARY OF THE DISCLOSURE

This application provides techniques, including circuits and designs, which can determine an amount of force applied, and changes in amounts of force applied, by the user when contacting a device, such as a touch device, and which can be incorporated into devices using touch recognition, touch elements of a GUI, and touch input or manipulation in an application program. This application also provides techniques, including devices which apply those techniques, which can determine an amount of force applied, and changes in amounts of force applied, by the user when contacting a device, such as a touch device, and in response thereto, provide additional functions available to a user of a touch device.

In one embodiment, techniques can include providing a force sensitive sensor incorporated into a touch device. For a first example, a force sensitive sensor can include an ultrasound device which can detect a measure of how forcefully a user is pressing, pushing, or otherwise contacting a touch device. For a second example, a force sensitive sensor can include one or more force sensing elements, each of which can detect a measure of applied force at a specific location on a surface of the device. For a third example, a force sensitive sensor can include one or more force sensing elements, which collectively can detect a measure of applied force in a gesture involving movement, or a designated region, on a surface of the device.

In one embodiment, techniques can include generating an ultrasonic pulse from a position within the device, reflecting the ultrasonic pulse from an interface between the surface of the device and either the air or a user's finger, and measuring a signal indicating an amount of applied force at the surface of the device, and possibly a particular location of applied force. An ultrasonic pulse can be directed at a particular one of a set of force sensing elements at a surface of the device, where each force sensing element distinguishes a particular location of applied force. The ultrasonic pulse can be reflected differently from the surface of the device depending upon an amount of applied force at the surface of the device, and possibly depending upon a location of that applied force. These elements have the effect that if a user applies force to a particular location at the surface of the device, the ultrasonic pulse will be reflected differently in response to the amount of that applied force, and possibly the location of that applied force.

In one embodiment, techniques can include generating an ultrasonic pulse by a piezoelectric element, such as a polyvinylidene difluoride (PVDF) element or another substance having a piezoelectric effect, in response to a triggering signal which generates the ultrasonic pulse. A particular ultrasonic pulse can be generated at a particular time, with a particular duration, or with a particular signal format (such as a particular frequency, pulse code, or waveform shape), in response to a triggering signal, with the effect that the reflection of the particular ultrasonic pulse can be recognized in response to the reflected form of that particular ultrasonic pulse. In embodiments in which there are a set of force sensing elements, each particular ultrasonic pulse can be distinguished at its generation point and time by a particular identifier (such as its time, duration, frequency, or signal format), with the effect that an applied force can be distinguished by which one or more force sensing elements reflects its own particular ultrasonic pulse. For example, each force sensing element can have its own particular time slot allocated for transmission, and its own particular time slot allocated for reception, in a round-robin cycle of ultrasonic pulses, with the effect that reflections from different force sensing elements can be distinguished.

In one embodiment, techniques can include measuring a reflection of the ultrasonic pulse from an interface between the surface of the device and either the air or a user's finger, such as by a piezoelectric element, such as a PVDF element or another substance having a piezoelectric effect, and generating a measurement signal in response to the reflected ultrasonic pulse. For example, a PVDF element suitable for transducing an electronic signal to an ultrasonic pulse can be used to receive a reflection of that ultrasonic pulse and transduce that reflection to a measurement signal indicating an amount of applied force at the surface of the device, and in response to an identifier of a particular force sensing element, possibly a location thereof.

In one embodiment, a reflection of the ultrasonic pulse from an interface between the surface of the device and either the air or the user's finger is responsive to an amount of applied force, or to a proxy thereof, such as an amount of area obscured by a deformable object (such as a user's finger) or an amount of wetting of the surface by a known object (again, such as a user's finger). For example, an amount of pressure or other measure of applied force by a user's finger can affect the degree to which the ultrasonic pulse is reflected by the interface between the surface of the device and the air (when there is no contact by the user's finger) or the interface between the surface of the device and the user's finger (when there is contact). This has the effect that the amplitude, and possibly other aspects of the ultrasonic signal, can be used to determine an amount of applied force.

In one embodiment, the ultrasonic pulse can be disposed so that it propagates around or through other elements of the device, such as a display element or a touch sensor. While it might occur that some portion of the ultrasonic pulse is absorbed or reflected by elements within the device, in one embodiment, a sensor for the reflected ultrasonic pulse is disposed to disregard spurious reflections and to recognize a relatively attenuated ultrasonic pulse, with the effect that the force sensor can identify those reflected ultrasonic pulses which have been reflected from the surface of the touch device.

In one embodiment, the force sensitive sensor operates independently of a second modality that determines one or more locations where the user is contacting the touch device, such as a capacitive touch sensor or other touch sensor. For example, a capacitive touch sensor can determine approximately in what location the user is contacting the touch device, while an ultrasound device can detect how forcefully the user is contacting the touch device.

In one embodiment, the force sensitive sensor includes one or more rows and one or more columns, the rows and columns being disposed to intersect in a set of individual force sense elements. For example, the individual force sense elements can be located in a substantially rectilinear array, with the rows disposed to define the individual rows of that rectilinear array, the columns disposed to define the individual columns of that rectilinear array, and the intersections of the rows and columns disposed to define the individual elements of that rectilinear array.

In one embodiment, the rows and columns can be disposed so that each row is controlled by a drive signal, each column is sensed by a sense circuit, and the intersections between each row and each column are disposed to generate and receive ultrasonic signals. For example the ultrasonic signals can include, first, an ultrasound wave which is directed at possible position where the user might apply force to the touch screen, and second, an ultrasound wave which is reflected from that position where the user actually does apply force to the touch screen. In one embodiment, techniques can include providing a touch sensitive sensor, in addition to the force sensitive sensor, which can determine a location where the user is actually touching the touch screen. For example, the touch sensitive sensor can include a capacitive sensor, which can determine a location of the user's touch (such as by the user's finger, another part of the user's body, or a stylus or other object).

In alternative embodiments, the force sensitive sensor can include a set of individual force sensing elements, disposed in an arrangement other than a set of rows and columns disposed to intersect in a set of individual force sense elements. For a first example, the force sensitive sensor can include a set of individual sensor elements whose operation is not necessarily due to intersection of rows and columns. For a second example, the force sensitive sensor can include a set of individual sensor elements disposed in an array or other pattern, which might include a rectilinear pattern or another pattern.

In alternative embodiments, the force sensitive sensor can include a set of individual sensor elements which are disposed in a pattern that allows force of touch to be detected, as to both location and amount, by multiple individual sensor elements operating in concert. A set of individual sensor elements can be each disposed to determine force of touch at a relative distance, and operate in conjunction so as to determine location and amount of that force of touch.

In various embodiments, the force sensitive sensor can include a set of individual force sensing elements, each of which couples an ultrasound-based signal to a surface of a display, such as a surface of a cover glass which can be touched by a user with varying degrees of applied force.

In one embodiment, the touch sensitive sensor and the force sensitive sensor can include separate circuits, components, elements, modules, or otherwise, which can operate in combination or conjunction to separately determine a location of touch and a force-of-touch. For example, a system including the touch panel, an operating system program, an application program, a user interface, or otherwise, can be responsive to the location of touch, the force-of-touch, a combination or conjunction of the two, or other factors.

For further examples, systems as described above can include, in addition to the force sensitive sensor, a touch sensitive sensor, as well as other sensors, such as a mouse, trackpad, fingerprint sensor, biometric sensor, voice activation or voice recognition sensor, facial recognition sensor, or otherwise.

Another embodiment may take the form of an electronic device including: a housing, an electronic component at least partially surrounded by the housing and connected to the housing; and one or more force sensitive sensors positioned beneath the electronic component and providing information with respect to applied force, the information including a measure of an amount of force presented at the one or more locations on an exterior of the device at which a touch occurs; wherein the force sensitive sensors are responsive to an ultrasonic pulse emitted through the electronic component and reflected from a surface of the device corresponding to the applied force.

Still another embodiment may take the form of a method for estimating a force applied to a surface, comprising the operations of: emitting an ultrasonic pulse towards a surface and through an electronic component; receiving a reflected ultrasonic signal from the surface, the reflected ultrasonic signal traveling through the component; determining a difference in energy between the ultrasonic pulse and the reflected ultrasonic signal; and estimating a force from the difference in energy.

Yet another embodiment may take the form of an apparatus for accepting a force as an input, comprising: at least one ultrasonic emitter; an optically transparent surface disposed above the at least one ultrasonic transmitter; a display disposed beneath the optically transparent surface and above the at least one ultrasonic emitter; at least one ultrasonic receiver positioned below the at least one ultrasonic emitter; and a measurement element operative to estimate a force applied to the optically transparent surface, the estimation based on an attenuation of an ultrasonic pulse emitted from the ultrasonic emitter, reflected from the optically transparent surface and received by the ultrasonic receiver.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

FIG. 1A is a front perspective view of a first example of a computing device incorporating a force sensing device.

FIG. 1B is a front perspective view of a second example of a computing device incorporating a force sensing device.

FIG. 1C is a front elevation view of a third example of a computing device incorporating the force sensing device.

FIG. 2 is a simplified cross-section view of the computing device taken along line 2-2 in FIG. 1A.

FIG. 3 shows a conceptual drawing of communication between a touch I/O device and a computing system.

FIG. 4 shows a conceptual drawing of a system including a touch sensing and force sensing I/O device.

FIG. 5A shows a conceptual drawing of a system including ultrasound-based sensing.

FIG. 5B shows a conceptual drawing of a system including ultrasound-based sensing.

FIG. 6A shows a conceptual drawing of a system including ultrasound-based force sensing, including row drivers and sense columns.

FIG. 6B shows a conceptual drawing of a system including ultrasound-based force sensing, including signals associated with row drivers and sense columns.

FIG. 7 shows a conceptual drawing of a system including ultrasound-based force sensing, including ultrasound-based reflection in non-force-applied and force-applied examples.

FIG. 8A is a first example of a timing diagram for the computing device.

FIG. 8B is a second example of a timing diagram for the computing device.

FIG. 8C is a third example of a timing diagram for the computing device.

### DETAILED DESCRIPTION

Terminology

The following terminology is exemplary, and not intended to be limiting in any way.

The text “touch sensing element”, and variants thereof, generally refers to one or more data sensing elements of any kind, including information sensed with respect to individual locations. For example and without limitation, a touch sensing element can sense data or other information with respect to a relatively small region of where a user is contacting a touch device.

The text “force sensing element”, and variants thereof, generally refers to one or more data sensing elements of any kind, including information sensed with respect to force-of-touch, whether at individual locations or otherwise. For example and without limitation, a force sensing element can include data or other information with respect to a relatively small region of where a user is forcibly contacting a device.

The text “force-of-touch”, and variants thereof, generally refers to a degree or measure of an amount of force being applied to a device. The degree or measure of an amount of force need not have any particular scale; for example, the measure of force-of-touch can be linear, logarithmic, or otherwise nonlinear, and can be adjusted periodically (or otherwise, such as a periodically or otherwise from time to time) in response to one or more factors, either relating to force-of-touch, location of touch, time, or otherwise.

After reading this application, those skilled in the art would recognize that these statements of terminology would be applicable to techniques, methods, physical elements, and systems (whether currently known or otherwise), including extensions thereof inferred or inferable by those skilled in the art after reading this application.

Overview

The present disclosure is related to a force sensing device that may be incorporated into a variety of electronic or computing devices, such as, but not limited to, computers, smart phones, tablet computers, track pads, and so on. The force sensing device may be used to detect one or more user force inputs on an input surface and then a processor (or processing element) may correlate the sensed inputs into a force measurement and provide those inputs to the computing device. In some embodiments, the force sensing device may be used to determine force inputs to a track pad, a display screen, or other input surface.

The force sensing device may include an input surface, a force sensing module, a substrate or support layer, and optionally a sensing layer that may detect another input characteristic than the force sensing layer. The input surface provides an engagement surface for a user, such as the external surface of a track pad or the cover glass for a display. In other words, the input surface may receive one or more user inputs directly or indirectly.

The force sensing module may include an ultrasonic module that may emit and detect ultrasonic pulses. In one example, the ultrasonic module may include a plurality of sensing elements arranged in rows or columns, where each of the sensing elements may selectively emit an ultrasonic pulse or other signal. The pulse may be transmitted through the components of the force sensing device, such as through the sensing layer and the input surface. When the pulse reaches the input surface, it may be reflected by a portion of the user (e.g., finger) or other object, which may reflect the pulse. The reflection of the pulse may vary based on distance that the particular sensing element receiving the pulse is from the input. Additionally, the degree of attenuation of the pulse may also be associated with a force magnitude associated with the input. For example, generally, as the input force on the input surface increases, the contacting object exerting the force may absorb a larger percentage of the pulse, such that the reflected pulse may be diminished correspondingly.

In embodiments where it is present, the sensing layer may be configured to sense characteristics different from the force sensing module. For example, the sensing layer may include capacitive sensors or other sensing elements. In a specific implantation, a multi-touch sensing layer may be incorporated into the force sensing device and may be used to enhance data regarding user inputs. As an example, touch inputs detected by the sense layer may be used to further refine the force input location, confirm the force input location, and/or correlate the force input to an input location. In the last example, the force sensitive device may not use the capacitive sensing of the force sensing device to estimate a location, which may reduce the processing required for the force sensing device. Additionally, in some embodiments, a touch sensitive device may be used to determine force inputs for a number of different touches. For example, the touch positions and force inputs may be used to estimate the input force at each touch location.

Force Sensitive Device and System

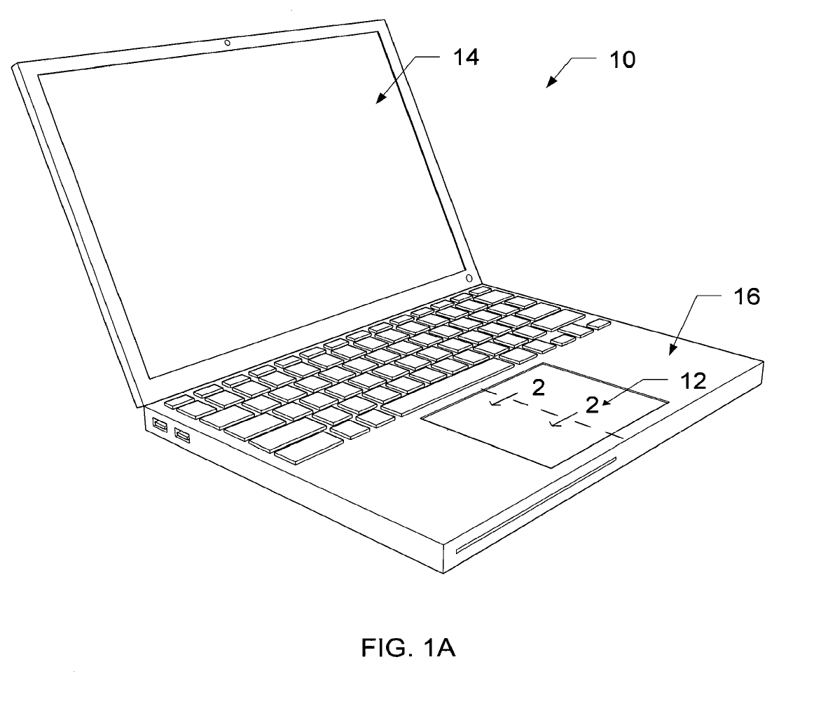

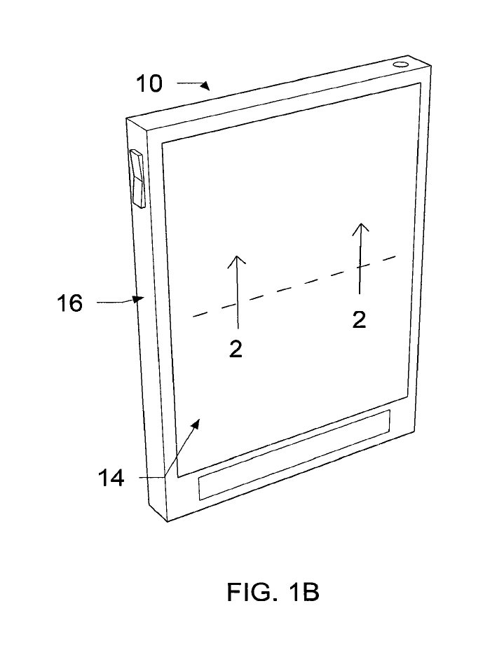

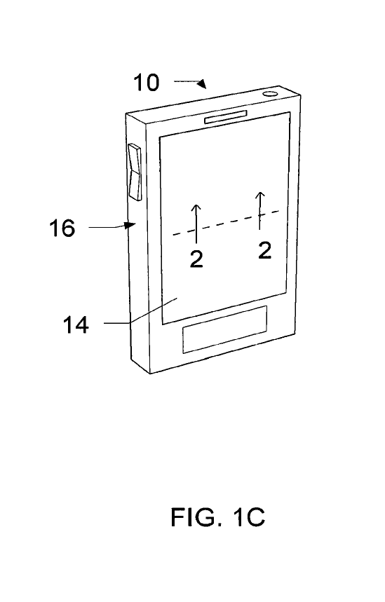

Turning now to the figures, illustrative electronic devices that may incorporate the force sensing device will be discussed in more detail. FIGS. 1A-1C illustrate various computing or electronic devices that may incorporate the force sensing device. With reference to FIG. 1A, the force sensing device may be incorporated into a computer 10, such as a laptop or desktop computer. The computer 10 may include a track pad 12 or other input surface, a display 14, and an enclosure 16 or frame. The enclosure 16 may extend around a portion of the track pad 12 and/or display 14. In the embodiment illustrated in FIG. 1A, the force sensing device may be incorporated into the track pad 12, the display 14, or both the track pad 12 and the display 14. In these embodiments, the force sensing device may be configured to detect force inputs to the track pad 12 and/or the display 14.

In some embodiments, the force sensing device may be incorporated into a tablet computer. FIG. 1B is a top perspective view of a tablet computer including the force sensing device. With reference to FIG. 1B, the table computer 10 may include the display 14 where the force sensing device is configured to detect force inputs to the display 14. In addition to the force sensing device, the display 14 may also include one or more touch sensors, such as a multi-touch capacitive grid, or the like. In these embodiments, the display 14 may detect both force inputs, as well as position or touch inputs.

In yet other embodiments, the force sensing device may be incorporated into a mobile computing device, such as a smart phone. FIG. 1C is a perspective view of a smart phone including the force sensing device. With reference to FIG. 1C, the smart phone 10 may include a display 14 and a frame or enclosure 16 substantially surrounding a perimeter of the display 14. In the embodiment illustrated in FIG. 1C, the force sensing device may be incorporated into the display 14. Similarly to the embodiment illustrated in FIG. 1B, in instances where the force sensing device may be incorporated into the display 14, the display 14 may also include one or more position or touch sensing devices in addition to the force sensing device.

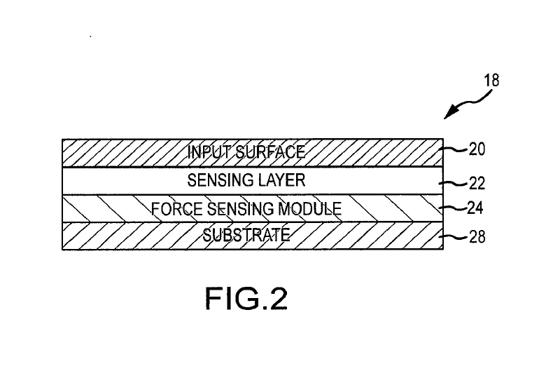

The force sensing device will now be discussed in more detail. FIG. 2 is a simplified cross-section view of the electronic device taken along line 2-2 in FIG. 1A. With reference to FIG. 2, the force sensing device 18 may include an input surface 20, a sensing layer 22, a force sensing module 24 or layer, and a substrate 28. As discussed above with respect to FIGS. 1A-1C, the input surface 20 may form an exterior surface (or a surface in communication with an exterior surface) of the track pad 12, the display 14, or other portions (such as the enclosure) of the computing device 10. In some embodiments, the input surface 20 may be at least partially translucent. For example, in embodiments where the force sensing device 18 is incorporated into a portion of the display 14.

The sensing layer 22 may be configured to sense one or more parameters correlated to a user input. In some embodiments, the sensing layer 22 may be configured to sense characteristics or parameters that may be different from the characteristics sensed by the force sensing module 24. For example, the sensing layer 22 may include one or more capacitive sensors that may be configured to detect input touches, e.g., multi-touch input surface including intersecting rows and columns. The sensing layer 22 may be omitted where additional data regarding the user inputs may not be desired. Additionally, the sensing layer 22 may provide additional data that may be used to enhance data sensed by the force sensing module 24 or may be different from the force sensing module. In some embodiments, there may be an air gap between the sensing layer 22 and the force sensing module 24. In other words, the force sensing module 24 and sensing layer may be spatially separated from each other defining a gap or spacing distance.

The substrate 28 may be substantially any support surface, such as a portion of an printed circuit board, the enclosure 16 or frame, or the like. Additionally, the substrate 28 may be configured to surround or at least partially surround one more sides of the sensing device 18.

In some embodiments, a display (e.g., a liquid crystal display) may be positioned beneath the input surface 20 or may form a portion of the input surface 20. Alternatively, the display may be positioned between other layers of the force sensing device. In these embodiments, visual output provided by the display may be visible through the input surface 20.

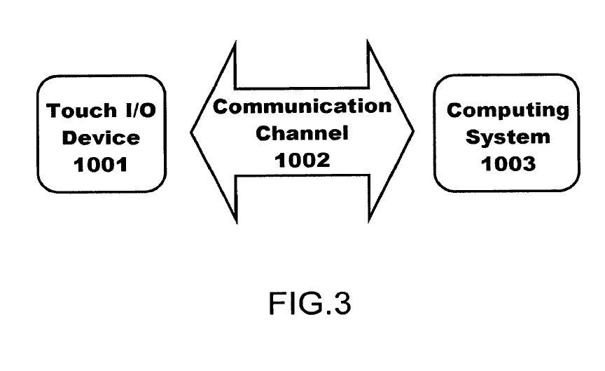

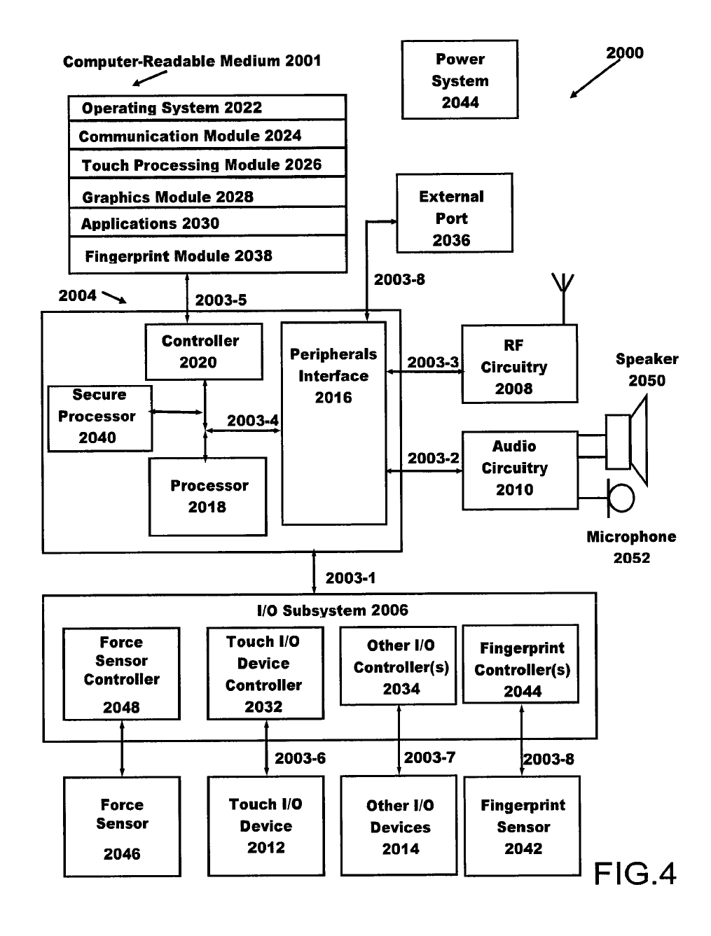

As generally discussed above, the force sensing device may be incorporated into one or more touch sensitive device. FIG. 3 shows a conceptual drawing of communication between a touch I/O device and a computing system. FIG. 4 shows a conceptual drawing of a system including a force sensitive touch device. With reference to FIGS. 3 and 4, additional features of the computing or electronic devices will be described. As generally described above, one or more embodiments may include a touch I/O device 1001 that can receive touch input and force input (such as possibly including touch locations and force of touch at those locations) for interacting with computing system 1003 or computing device 10 (such as shown in the FIGS. 1A-1C) via wired or wireless communication channel 1002. Touch I/O device 1001 may be used to provide user input to computing system 1003 in lieu of or in combination with other input devices such as a keyboard, mouse, or possibly other devices. In alternative embodiments, touch I/O device 1001 may be used in conjunction with other input devices, such as in addition to or in lieu of a mouse, trackpad, or possibly another pointing device. One or more touch I/O devices 1001 may be used for providing user input to computing system 1003. Touch I/O device 1001 may be an integral part of computing system 1003 (e.g., touch screen on a laptop) or may be separate from computing system 1003; see, for example, FIGS. 1A-1C.

Touch I/O device 1001 may include a touch sensitive and force sensitive panel which is wholly or partially transparent, semitransparent, non-transparent, opaque or any combination thereof. Touch I/O device 1001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard, disposed on a trackpad or other pointing device), any multi-dimensional object having a touch sensitive surface for receiving touch input, or another type of input device or input/output device.

In one example, such as shown in FIGS. 1B and 1C, and with reference to FIG. 4, the touch I/O device 1001 embodied as a touch screen may include a transparent and/or semitransparent touch sensitive and force sensitive panel at least partially or wholly positioned over at least a portion of a display. (Although the touch sensitive and force sensitive panel is described as at least partially or wholly positioned over at least a portion of a display, in alternative embodiments, at least a portion of circuitry or other elements used in embodiments of the touch sensitive and force sensitive panel may be at least positioned partially or wholly positioned under at least a portion of a display, interleaved with circuits used with at least a portion of a display, or otherwise.) According to this embodiment, touch I/O device 1001 functions to display graphical data transmitted from computing system 1003 (and/or another source) and also functions to receive user input. In other embodiments, touch I/O device 1001 may be embodied as an integrated touch screen where touch sensitive and force sensitive components/devices are integral with display components/devices. In still other embodiments a touch screen may be used as a supplemental or additional display screen for displaying supplemental or the same graphical data as a primary display and to receive touch input, including possibly touch locations and force of touch at those locations.

Touch I/O device 1001 may be configured to detect the location of one or more touches or near touches on device 1001, and where applicable, force of those touches, based on capacitive, resistive, optical, acoustic, inductive, mechanical, chemical, or electromagnetic measurements, in lieu of or in combination or conjunction with any phenomena that can be measured with respect to the occurrences of the one or more touches or near touches, and where applicable, force of those touches, in proximity to device 1001. Software, hardware, firmware or any combination thereof may be used to process the measurements of the detected touches, and where applicable, force of those touches, to identify and track one or more gestures. A gesture may correspond to stationary or non-stationary, single or multiple, touches or near touches, and where applicable, force of those touches, on touch I/O device 1001. A gesture may be performed by moving one or more fingers or other objects in a particular manner on touch I/O device 1001 such as tapping, pressing, rocking, scrubbing, twisting, changing orientation, pressing with varying pressure and the like at essentially the same time, contiguously, consecutively, or otherwise. A gesture may be characterized by, but is not limited to a pinching, sliding, swiping, rotating, flexing, dragging, tapping, pushing and/or releasing, or other motion between or with any other finger or fingers, or any other portion of the body or other object. A single gesture may be performed with one or more hands, or any other portion of the body or other object by one or more users, or any combination thereof.

Computing system 1003 may drive a display with graphical data to display a graphical user interface (GUI). The GUI may be configured to receive touch input, and where applicable, force of that touch input, via touch I/O device 1001. Embodied as a touch screen, touch I/O device 1001 may display the GUI. Alternatively, the GUI may be displayed on a display separate from touch I/O device 1001. The GUI may include graphical elements displayed at particular locations within the interface. Graphical elements may include but are not limited to a variety of displayed virtual input devices including virtual scroll wheels, a virtual keyboard, virtual knobs or dials, virtual buttons, virtual levers, any virtual UI, and the like. A user may perform gestures at one or more particular locations on touch I/O device 1001 which may be associated with the graphical elements of the GUI. In other embodiments, the user may perform gestures at one or more locations that are independent of the locations of graphical elements of the GUI. Gestures performed on touch I/O device 1001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen. Alternatively, a touch pad generally provides indirect interaction. Gestures may also affect non-displayed GUI elements (e.g., causing user interfaces to appear) or may affect other actions within computing system 1003 (e.g., affect a state or mode of a GUI, application, or operating system). Gestures may or may not be performed on touch I/O device 1001 in conjunction with a displayed cursor. For instance, in the case in which gestures are performed on a touchpad, a cursor (or pointer) may be displayed on a display screen or touch screen and the cursor may be controlled via touch input, and where applicable, force of that touch input, on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via communication channel 1002 in response to or based on the touch or near touches, and where applicable, force of those touches, on touch I/O device 1001. Feedback may be transmitted optically, mechanically, electrically, olfactory, acoustically, haptically, or the like or any combination thereof and in a variable or non-variable manner.

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other (portable or non-portable) system or device adaptable to the inclusion of system architecture 2000, including combinations of two or more of these types of devices. FIG. 4 is a block diagram of one embodiment of system 2000 that generally includes one or more computer-readable mediums 2001, processing system 2004, Input/Output (I/O) subsystem 2006, electromagnetic frequency (EMF) circuitry (such as possibly radio frequency or other frequency circuitry) 2008 and audio circuitry 2010. These components may be coupled by one or more communication buses or signal lines 2003. Each such bus or signal line may be denoted in the form 2003-X, where X can be a unique number. The bus or signal line may carry data of the appropriate type between components; each bus or signal line may differ from other buses/lines, but may perform generally similar operations.

It should be apparent that the architecture shown in FIG. 4 is only one example architecture of system 2000, and that system 2000 could have more or fewer components than shown, or a different configuration of components. The various components shown in FIG. 4 can be implemented in hardware, software, firmware or any combination thereof, including one or more signal processing and/or application specific integrated circuits.

EMF circuitry 2008 is used to send and receive information over a wireless link or network to one or more other devices and includes well-known circuitry for performing this function. EMF circuitry 2008 and audio circuitry 2010 are coupled to processing system 2004 via peripherals interface 2016. Interface 2016 includes various known components for establishing and maintaining communication between peripherals and processing system 2004. Audio circuitry 2010 is coupled to audio speaker 2050 and microphone 2052 and includes known circuitry for processing voice signals received from interface 2016 to enable a user to communicate in real-time with other users. In some embodiments, audio circuitry 2010 includes a headphone jack (not shown).

Peripherals interface 2016 couples the input and output peripherals of the system to processor 2018 and computer-readable medium 2001. One or more processors 2018 communicate with one or more computer-readable mediums 2001 via controller 2020. Computer-readable medium 2001 can be any device or medium that can store code and/or data for use by one or more processors 2018. Medium 2001 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 2001 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processors 2018 run various software components stored in medium 2001 to perform various functions for system 2000. In some embodiments, the software components include operating system 2022, communication module (or set of instructions) 2024, touch and force-of-touch processing module (or set of instructions) 2026, graphics module (or set of instructions) 2028, one or more applications (or set of instructions) 2030, and fingerprint sensing module (or set of instructions) 2038. Each of these modules and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments. In some embodiments, medium 2001 may store a subset of the modules and data structures identified above. Furthermore, medium 2001 may store additional modules and data structures not described above.

Operating system 2022 includes various procedures, sets of instructions, software components and/or drivers for controlling and managing general system tasks (e.g., memory management, storage device control, power management, etc.) and facilitates communication between various hardware and software components.

Communication module 2024 facilitates communication with other devices over one or more external ports 2036 or via EMF circuitry 2008 and includes various software components for handling data received from EMF circuitry 2008 and/or external port 2036.

Graphics module 2028 includes various known software components for rendering, animating and displaying graphical objects on a display surface. In embodiments in which touch I/O element 2012 is a touch sensitive and force sensitive display (e.g., touch screen), graphics module 2028 includes components for rendering, displaying, and animating objects on the touch sensitive and force sensitive display.

One or more applications 2030 can include any applications installed on system 2000, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system, also sometimes referred to herein as “GPS”), a music player, and otherwise.

Touch and force-of-touch processing module 2026 includes various software components for performing various tasks associated with touch I/O element 2012 including but not limited to receiving and processing touch input and force-of-touch input received from I/O device 2012 via touch I/O element controller 2032.

System 2000 may further include fingerprint sensing module 2038 for performing the method/functions as described herein in connection with other figures shown and described herein.

I/O subsystem 2006 is coupled to touch I/O element 2012 and one or more other I/O devices 2014 for controlling or performing various functions. Touch I/O element 2012 communicates with processing system 2004 via touch I/O element controller 2032, which includes various components for processing user touch input and force-of-touch input (e.g., scanning hardware). One or more other input controllers 2034 receives/sends electrical signals from/to other I/O devices 2014. Other I/O devices 2014 may include physical buttons, dials, slider switches, sticks, keyboards, touch pads, additional display screens, or any combination thereof.

If embodied as a touch screen, touch I/O element 2012 displays visual output to the user in a GUI. The visual output may include text, graphics, video, and any combination thereof. Some or all of the visual output may correspond to user-interface objects. Touch I/O element 2012 forms a touch-sensitive and force-sensitive surface that accepts touch input and force-of-touch input from the user. Touch I/O element 2012 and touch screen controller 2032 (along with any associated modules and/or sets of instructions in medium 2001) detects and tracks touches or near touches, and where applicable, force of those touches (and any movement or release of the touch, and any change in the force of the touch) on touch I/O element 2012 and converts the detected touch input and force-of-touch input into interaction with graphical objects, such as one or more user-interface objects. In the case in which device 2012 is embodied as a touch screen, the user can directly interact with graphical objects that are displayed on the touch screen. Alternatively, in the case in which device 2012 is embodied as a touch device other than a touch screen (e.g., a touch pad or trackpad), the user may indirectly interact with graphical objects that are displayed on a separate display screen embodied as I/O device 2014.

Touch I/O element 2012 may be analogous to the multi-touch sensitive surface described in the following U.S. Pat. Nos. 6,323,846; 6,570,557; and/or 6,677,932; and/or U.S. Patent Publication 2002/0015024A1, each of which is hereby incorporated by reference.

Embodiments in which touch I/O element 2012 is a touch screen, the touch screen may use LCD (liquid crystal display) technology, LPD (light emitting polymer display) technology, OLED (organic LED), or OEL (organic electro luminescence), although other display technologies may be used in other embodiments.

Feedback may be provided by touch I/O element 2012 based on the user's touch, and force-of-touch, input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 2000 also includes power system 2044 for powering the various hardware components and may include a power management system, one or more power sources, a recharging system, a power failure detection circuit, a power converter or inverter, a power status indicator and any other components typically associated with the generation, management and distribution of power in portable devices.

In some embodiments, peripherals interface 2016, one or more processors 2018, and memory controller 2020 may be implemented on a single chip, such as processing system 2004. In some other embodiments, they may be implemented on separate chips.

Ultrasound-Based Force Sensing

Although this application primarily describes particular embodiments with respect to configuration of the system including ultrasound-based sensing, in the context of this disclosure, there is no particular requirement for any limitation to those particular embodiments. While particular elements are described for layering of elements in one embodiment, alternative elements would also be workable.

For example, while this application primarily describes embodiments in which a set of ultrasound-based force sensing elements are disposed below a set of presentation elements and below a set of touch sensing elements, in alternative embodiments, there is no particular requirement for that ordering of elements. For example, the ultrasound-based force sensing elements could be disposed above the presentation elements and could be constructed or arranged so they do not interfere with the presentation elements, such as being translucent or transparent, or with the presentation elements disposed between individual force sensing elements.

For example, the ultrasound-based force sensing elements could be disposed above the presentation elements, but so arranged that the force sensing elements are interspersed with the presentation elements, with the effect that the presentation elements can present light and color to a user through the cover glass, without obstruction by any of the force sensing elements.

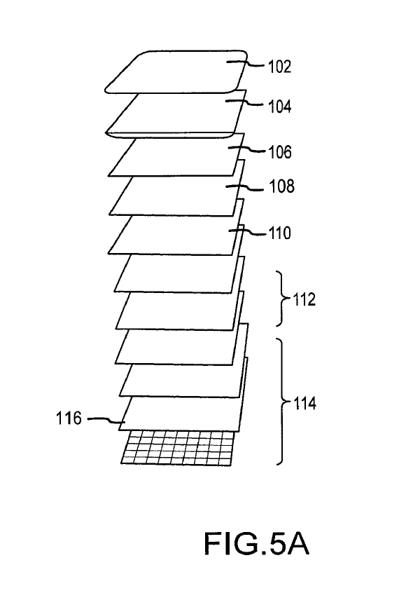

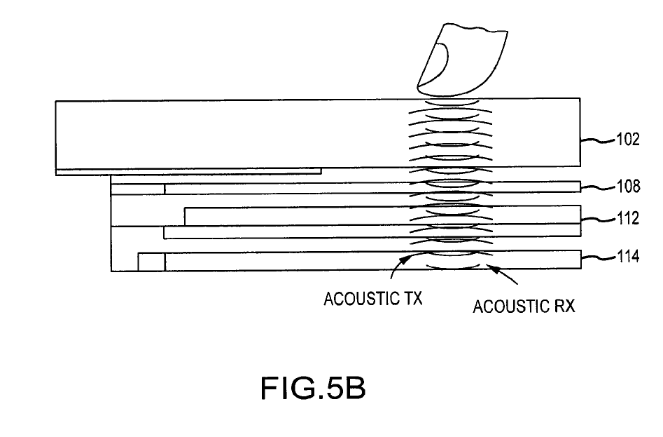

FIG. 5A shows a conceptual drawing of a system including ultrasound-based sensing.

FIG. 5B shows a conceptual drawing of a system including ultrasound-based sensing.

A system including ultrasound-based sensing with separate touch modules includes a touch I/O element 2012 as described herein, including a cover glass (CG) element 102, which may be touched by the user, and for which touch may be sensed and force-of-touch may be sensed. With brief reference to FIG. 2, the cover glass element 102 may form the input surface, and as such may be substantially any type of material or structure. An ultrasound-based force sensing element is disposed below the cover glass. A touch sensing element 108 is also disposed below the cover glass or integral therewith.

In one embodiment, touch I/O element 2012 can include the cover glass 102 element 102, which in some implementations can have a thickness of approximately 900 microns. The cover glass 102 element might be used to receive touch and applied force from the user. The cover glass 102 element can be constructed using one or more layers of glass, chemically treated glass, sapphire, or one or more other substances.

In one embodiment, touch I/O element 2012 can include an ink layer 104 disposed below the cover glass element, which can have a thickness in some implementations of approximately 50 microns. In some embodiments, the ink layer 104 may be a black mask region or non-active display region surrounding a border of the display. In other embodiments, the ink layer 104 may be omitted or may be formed of active display components.

In one embodiment, touch I/O element 2012 can include a first optically clear adhesive (OCA) 106 element disposed below the ink 104, which can have a thickness of approximately 150 microns. In alternative embodiments, other adhesive elements which do not interfere with operation of the other elements of the system could be used.

In one embodiment, touch I/O element 2012 can include a touch sensor element 108, which can have a thickness of approximately 120 microns. As discussed above, the touch sensor may be a capacitive sensing element or a series of capacitive sensing elements arranged in a grid or other configuration.

In one embodiment, touch I/O element 2012 can include a second first optically clear adhesive (OCA) 110 element disposed below the touch sensor element 108, which in some implementations can have a thickness of approximately 100 microns. As described above with respect to the first OCA element 106, in alternative embodiments, other adhesive elements which do not interfere with operation of the other elements of the system could be used.

In one embodiment, touch I/O element 2012 can include an OLED and polarizer element 112, which can have a thickness of approximately 330 microns. The thickness of the display layer may be varied depending on the type of display used, as well as the size, resolution, and so on, of the display. Accordingly, the thickness listed is illustrative only. Additionally, although this application primarily describes an embodiment using an OLED and polarizer element 112, which can have the capability of presenting an image to a user through the cover glass, in the context of the invention, many alternatives exist which would also be workable. In alternative embodiments, the OLED and polarizer element 112 can be disposed in another location in a stack of elements disposed below the cover glass. For example, the OLED and polarizer element 112 can be disposed either above or below the touch sensor 108, and either above or below the force sensor 114. In such cases, either the touch sensor 108 or the force sensor 114 can be constructed of a transparent or translucent material, or otherwise disposed so that presentation of an image to a user can be performed. As yet another example, the display layer may be a liquid crystal layer, a plasma layer, or the like. Depending on the type of display used, the polarizer may be omitted or otherwise varied.

In one embodiment, touch I/O element 2012 can include a third first optically clear adhesive (OCA) element disposed below the touch sensor element, which in some implementations can have a thickness of approximately 100 microns. As described above with respect to the first OCA element 106, in alternative embodiments, other adhesive elements which do not interfere with operation of the other elements of the system could be used.

In one embodiment, touch I/O element 2012 can include a force sensor element disposed below the second first optically clear adhesive (OCA) element, which can have a thickness of approximately 50 microns.

As described above, while this application describes a particular ordering of layers, in alternative embodiments, other orderings would be workable, and are within the scope and spirit of the invention. Additionally, although sample thicknesses are given, these are meant as illustrative only and may be varied as desired. Similarly, as described above, other substances other than OCA would be workable, and are within the scope and spirit of the invention. Similarly, as described above, other materials other than PVDF, such as other piezoelectric substances 116 or other circuits or elements which could generate a signal capable of reflection from a surface of the cover glass, or otherwise detecting force of touch, would be workable, and are within the scope and spirit of the invention. Similarly, as described above, elements which are described to have a top and a bottom set of circuits for activation, would in alternative embodiments also be workable with only a single layer of circuits for activation, such as a single layer using three electrodes for activating individual elements, rather than two layers each having only two electrodes coupled to each element.

It should be noted that FIG. 5B provides for sample thickness levels for certain layers. For example, the touch sensor 108 and adhesive layers may have a thickness of approximately 270 um, the OLED display and adhesive may have a thickness of approximately 430 um, and the ultrasonic or force sensing module may have a thickness of approximately 350 um. However, it should be noted that any discussion of thicknesses for any particular layer or group of layers is illustrative only and many other implementations are envisioned and expected. Accordingly, the discussion of any particular thickness should not be understood as limiting, but merely exemplary.

With reference to FIG. 5, the ultrasonic or force sensing module may include a piezoelectric material, such as PVDF. The piezoelectric film 116 may be incorporated into the ultrasonic module 116 and may be used to generate an ultrasonic pulse. Additionally, the piezoelectric film 116 may be configured to receive a reflection of that ultrasonic pulse and transduce that reflection to a measurement signal indicating an amount of applied force at the surface of the device, and in response to an identifier of a particular force sensing element, possibly a location thereof. This will be discussed in more detail below.

Row and Column Circuits for Ultrasound-Based Sensing

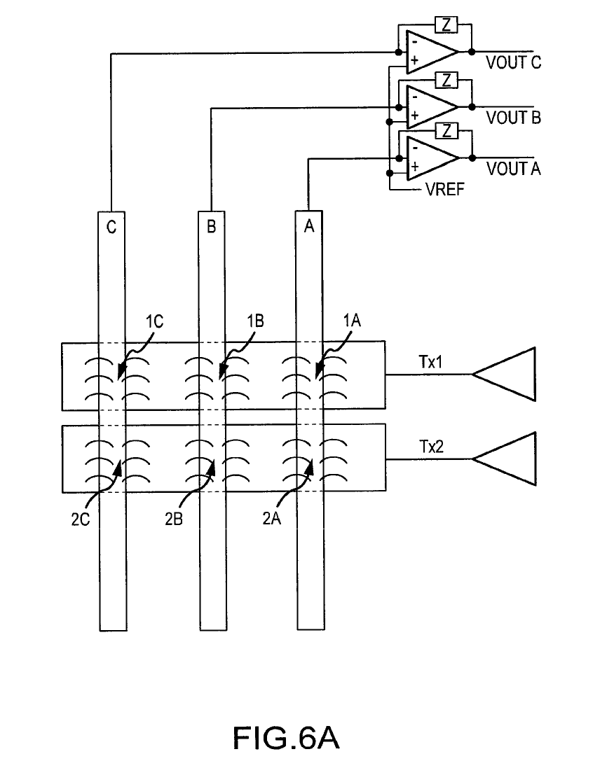

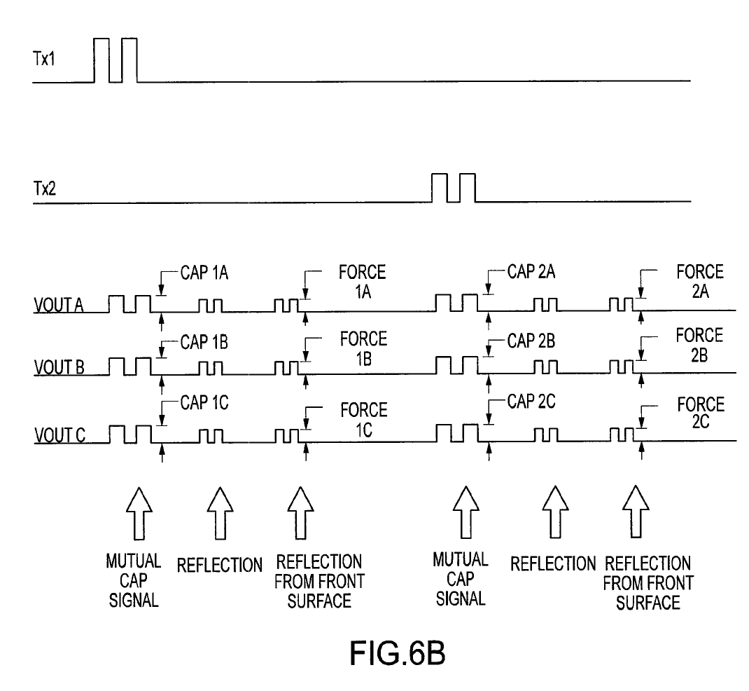

FIG. 6A shows a conceptual drawing of a system including ultrasound-based force sensing, including row drivers and sense columns.

FIG. 6B shows a conceptual drawing of a system including ultrasound-based force sensing, including signals associated with row drivers and sense columns.

In one embodiment, the ultrasound-based sensing element, which may include the piezoelectric layer 116, includes one or more rows and one or more columns, disposed in an overlapping manner, such as rectilinearly, with the effect of identifying one or more force sensing elements at each intersection of a particular such row and a particular such column. This has the effect that force of touch can be determined independently at each particular one such force sensing element. In some embodiments, the piezoelectric layer may be film deposited over the one or more rows and columns which may apply an electric current to the piezoelectric film. In these embodiments, as the current is applied, the piezoelectric material may emit an ultrasonic pulse. Additionally, as the piezoelectric layer receives an ultrasonic pulse, it may generate an electric current. In other embodiments, the piezoelectric material may be incorporated into the rows/columns and as the current is applied to the rows and columns by the respective drivers, the piezoelectric material may emit an ultrasonic pule or pulses.

Similarly, in one embodiment, the touch sensing element includes one or more rows and one or more columns, disposed in an overlapping manner, such as rectilinearly, with the effect of identifying one or more touch sensing elements at each intersection of a particular such row and the particular such column. This has the effect that location of touch can be determined independently at each particular one such touch sensing element. In one embodiment, each touch sensing element includes a device capable of measuring a capacitance between the touch I/O element 2012 (or more particularly, and element below the cover glass of the touch device 2012) and the user's finger, or other body part or touching device. This has the effect that, when the user brings their finger near to or touching the touch I/O element 2012, one or more capacitance sense elements detect the location of the user's finger, and produce one or more signals indicating one or more locations at which the user is contacting the touch I/O element 2012.

In one embodiment, the ultrasound-based sensing elements have their rows coupled to one or more triggering and driving circuits (such as shown in the figure as TX1 and TX2, corresponding to rows 1 and 2, respectively), each of which is coupled to a corresponding row of the ultrasound-based sensing element. Each corresponding row of the ultrasound-based sensing element is coupled to a sequence of one or more ultrasound-based sensors. Each ultrasound-based sensor, which may be the piezoelectric material, can, when triggered, emit an ultrasonic pulse or other signal (such as shown in the figure as TX1 and TX1, again corresponding to rows 1 and 2, respectively), which is transmitted from the ultrasound-based sensor, through the elements described with respect to the FIGS. 5A and 5B, and to the surface of the cover glass.

The triggering and driving circuits generate one or more pulses which are transmitted to the rows of the ultrasound-based sensing device, each of which is coupled to a corresponding row of individual ultrasound-based sensing elements. Similarly, in one embodiment, the individual ultrasound-based sensing elements have their columns coupled to one or more sensing and receiving circuits, each of which is coupled to a corresponding column of the ultrasound-based sensing device. Collectively, this has the effect that one or more rows of the ultrasound-based sensing device are driven by corresponding triggering signals, which are coupled to one or more columns of the ultrasound-based sensing device, which are sensed by corresponding receiving circuits.

When the ultrasonic pulse reaches the front surface of the cover glass, it would be reflected by the user's fingertip, or other part of the user's body, or other touching element (such as a soft-ended stylus or similar device). This can have the effect that the ultrasonic pulse would be reflected, at least in part, back to the ultrasound-based sensor which emitted that ultrasonic pulse. The reflected ultrasonic pulse is received by one or more ultrasound-based sensors, including the ultrasound-based sensor which emitted that ultrasonic pulse, with the effect that when the user touches the touch I/O element 2012, a signal is received which is responsive to the force of touch impressed on the cover glass by the user.

One or more such reflections from the interface between the front surface of the cover glass and either the air or the user's finger can be identified by the columns of the ultrasound-based sensing element (such as shown in the figure as Vout A, Vout B, and Vout C, corresponding to columns A, B, and C, respectively). Each such column is coupled to a sense amplifier, such as shown in the figure including a reference voltage Vref (such as a grounding voltage or other reference voltage), an amplifier, and a feedback impedance element (such as a capacitor, resistor, or combination or conjunction thereof, or otherwise). Although each sense amplifier is shown in the figure as coupled to only one sensing element, in the context of the invention, there is no particular requirement for any such limitation. For example, one or more such sense amplifiers can include a differential sense amplifier, or other sense amplifier design.

In one embodiment, each sense amplifier is disposed so that it generates a relatively maximal response in those cases when the ultrasonic reflection from the interface between the front of the cover glass and the user's finger is due to a force directly above the force sense element. This has the effect that when the force sense element receives a force of touch from the user, the relatively maximal response to that force of touch impressed on the cover glass by the user is primarily from the ultrasound-based sensing element at the individual row/column associated with the location where that force of touch is relatively maximal. To the extent that force of touch impressed on the cover glass by the user is also impressed on other locations on the cover glass, the ultrasound-based sensing element at the individual row/column associated with those other locations would also be responsive.

In one embodiment, each sense amplifier is also disposed so that it generates a relatively minimal response in those cases when the ultrasonic reflection from the front of the cover glass is due to a force from a location relatively far from directly above the force sense element. For example, in the case that the ultrasonic reflection is from a portion of the ultrasonic pulse which radiates at an angle from the ultrasound-based sensor, and is similarly reflected back at that angle, the arrival time of that ultrasonic pulse would be sufficiently different from a direct up-and-down reflection that the sense amplifier can be disposed to disregard that portion of the reflection of the ultrasonic pulse. This has the effect that the sense amplifier can be disposed to only respond to those cases when force of touch is impressed on the cover glass by the user directly above the sense amplifier.

For example, an ultrasonic pulse can be generated by a triggering pulse from driving circuit, such as TX1 or TX2, with the effect of providing a first set of (unwanted) reflections and a second set of (wanted) reflections, one set for each of Vout A, Vout B, and Vout C. The unwanted reflections might be responsive to reflections from other ultrasonic pulses, from ultrasonic pulses that are reflected from elements other than the front of the cover glass, or interfaces between such elements, or otherwise. For example, the unwanted reflections might occur at a time after the triggering pulse from driving circuit, such as less than about 450 nanoseconds after the triggering pulse, but before an expected time for the ultrasonic pulse to travel to the front of the cover glass and be reflected, such as more than about 450 nanoseconds after the triggering pulse. In such cases, the receiving and sensing circuits would be disposed to decline to respond to those reflections which are not within the expected window of time duration for a response from the correct force sensing element.

In one embodiment, the touch I/O element 2012 can include a capacitive touch sensing device, which can determine a location, or an approximate location, at which the user contacts, or nearly contacts, the touch I/O element 2012. For example, the capacitive touch sensing device can include a set of capacitive touch sensors, each of which is disposed to determine if the user contacts, or nearly contacts, the touch I/O element 2012 at one or more capacitive touch sensing elements.

In one embodiment, the touch I/O element 2012 can combine information from the capacitive touch sensing device and the ultrasound-based force sensing device, with the effect of determining both a location of touch and a force of touch by the user.

In one embodiment, the touch I/O element 2012 can maintain the ultrasound-based force sensing device in a relatively dormant state, with the effect of reducing ongoing power use, until such time as the capacitive touch sensing device indicates that there is a contact or near contact by the user on the touch I/O element 2012. For a first example, once there is a contact or near contact by the user on the touch I/O element 2012, the touch I/O element 2012 can activate the ultrasound-based force sensing device, with the effect that the ultrasound-based force sensing device need not draw power at times while the user is not contacting the touch I/O element 2012. For a second example, once there is a contact or near contact by the user on the touch I/O element 2012, the touch I/O element 2012 can activate a portion of the ultrasound-based force sensing device associated with the location where the contact or near contact occurs, with the effect that only those portions of the ultrasound-based force sensing device need draw power only at locations which are associated with places where the user is contacting the touch I/O element 2012.

Ultrasound-Based Force Sensing Using Reflection

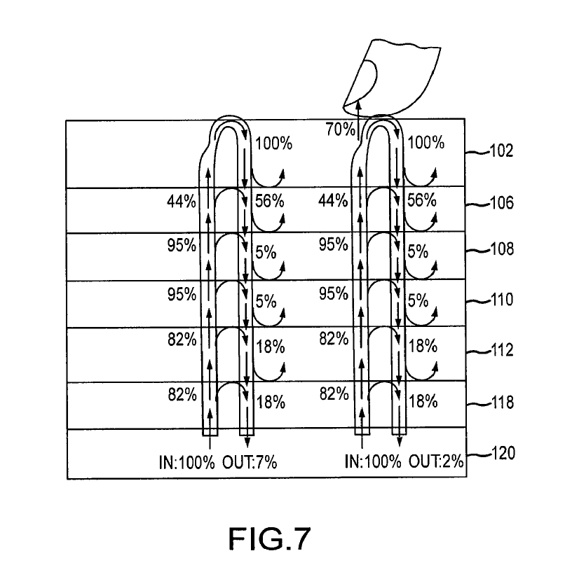

FIG. 7 shows a conceptual drawing of a system including ultrasound-based force sensing, including ultrasound-based reflection in non-force-applied and force-applied examples.

An ultrasound-based force sensor in this example includes a transmitter/receiver 120, which is disposed to emit ultrasonic pulses when triggered by an electronic circuit (not shown in this figure), and is disposed to receive ultrasonic pulses and generate a signal in response thereto. In some embodiments, the transmitter/receiver 120 may include the piezoelectric material 118, which may be configured to emit an ultrasonic signal in response to a current, as well as create a current in response to an ultrasonic signal. In this manner, the piezoelectric layer may be used both to transmit ultrasonic signals, as well as receive ultrasonic signals. For example, the current generated by the piezoelectric material may correspond to the strength of the received signal.

With reference to FIGS. 2, 5A, 5B, and 7, and as described above, the transmitter/receiver 120 is disposed below an adhesive layer 118, which is disposed below a display layer 112, which is disposed below a second OCA (adhesive) layer 110 (or another layer having suitable properties, as described above), which is disposed below a touch sensor layer 108, which is disposed below a first OCA (adhesive) layer 106 (or another layer having suitable properties, as described above), which is disposed below a cover glass layer 102, which has a surface at which it has an interface with either air (when there is no contact by a user) or a user's finger (when there is a contact by a user).

An ultrasonic pulse is generated at the transmitter/receiver 120, and directed toward the surface of the cover glass 102. As shown in the figure, at each interface between layers, some fraction of the energy of the ultrasonic pulse is reflected by the interface between layers, and some fraction of the energy of the ultrasonic pulse is transmitted through the interface to the next layer.

In one embodiment, in which the adhesive 118 and OCA layers 106, 110 have a consistency and density substantially similar to water, approximately 82% of the energy of the ultrasonic pulse is transmitted through the interface between the adhesive layer and the display layer, while approximately 18% of that energy is reflected. Similarly, in such embodiments, approximately 82% of the remaining energy of the ultrasonic pulse is transmitted through the interface between the display layer and the second OCA layer, while approximately 18% of that remaining energy is reflected. Similarly, in such embodiments, approximately 95% of the remaining energy of the ultrasonic pulse is transmitted through the interface between the second OCA layer and the touch sensor layer 108, while approximately 5% of that remaining energy is reflected. Similarly, in such embodiments, approximately 95% of the remaining energy of the ultrasonic pulse is transmitted through the interface between the touch sensor layer 108 and the first OCA layer 106, while approximately 5% of that remaining energy is reflected. Similarly, in such embodiments, approximately 44% of the remaining energy of the ultrasonic pulse is transmitted through the interface between the first OCA layer 106 and the cover glass 102, while approximately 56% of that remaining energy is reflected.

When there is no contact by the user, substantially all of the remaining energy of the ultrasonic pulse is reflected by the interface between the cover glass 102 and air. However, similar losses of energy of the ultrasonic pulse occur as the ultrasonic pulse is returned from the interface between the cover glass 102 and air back to the transmitter/receiver 120. As shown in the figure, when there is no contact by the user, approximately 7% of the energy of the ultrasonic pulse is returned from the interface between the cover glass 102 and air back to the transmitter/receiver 120.

When there is contact by the user, such as when the user's finger applies force to the cover glass 102, approximately 70% of the remaining energy of the ultrasonic pulse is absorbed by the user's finger, and approximately 30% of the remaining energy of the ultrasonic pulse is reflected. These fractions might vary in response to various factors, such as an amount of a force sensing element covered by the user's finger, an amount of wetting of the cover glass 102 by the user's finger, a measure of heat or humidity in or on the user's finger, and possibly other factors. As noted above, similar losses of energy of the ultrasonic pulse occur as the ultrasonic pulse is returned from the interface between the cover glass 102 and air back to the transmitter/receiver 120. As shown in the figure, when there is contact by the user, approximately 2% of the energy of the ultrasonic pulse is returned from the interface between the cover glass 102 and air back to the transmitter/receiver 120.

In alternative embodiments, in which the adhesive and OCA layers have a consistency and density substantially similar to a polyimide substance, the impedance match between layers is more conducive to transmission of the ultrasonic pulse, with the effect that approximately 48% of the energy of the ultrasonic pulse is returned from the interface between the cover glass 102 and air back to the transmitter/receiver 120 when there is no contact by the user, and approximately 15% of the energy of the ultrasonic pulse is returned from the interface between the cover glass 102 and air back to the transmitter/receiver 120 when there is contact by the user.

However, those skilled in the art will notice, after reading this application, that a ratio between an amount of energy of the ultrasonic pulse is returned from the interface between the cover glass 102 and air back to the transmitter/receiver 120 may be approximately 3.5 to 1, whether the adhesive and OCA layers have a consistency and density substantially similar to water or to a polyimide substance, with the effect that the transmitter/receiver can determine a difference between whether there is contact by the user's finger or whether there is no such contact.

Similarly, it should be noted that there are likely to be substantial spurious reflections of the ultrasonic pulse, both due to (A) internal reflections between layers, and (B) portions of the ultrasonic pulse which are not transmitted directly from the transmitter/receiver toward the interface between the cover glass and air, or which are not transmitted directly from the interface between the cover glass and air to the transmitter/receiver. In some embodiments, the transmitter/receiver can restrict its reception of individual ultrasonic pulses to particular times or particular aspects of the ultrasonic pulse, the transmitter/receiver can determine which reflections are from the interface between the cover glass and air (thus, should be considered when determining an amount of applied force), and which reflections are spurious internal reflections, that is, other than from the interface between the cover glass and air (thus, should not be considered when determining an amount of applied force).

Timing Diagram

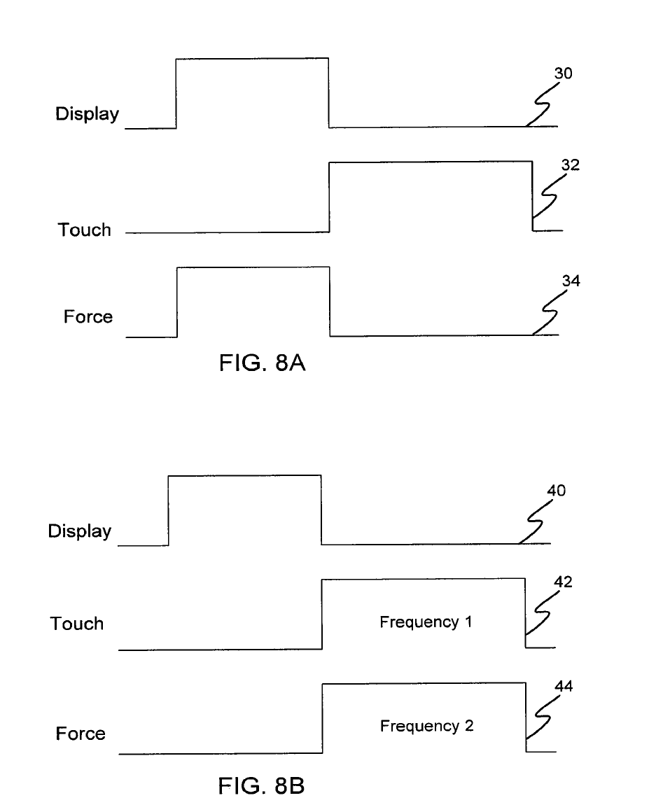

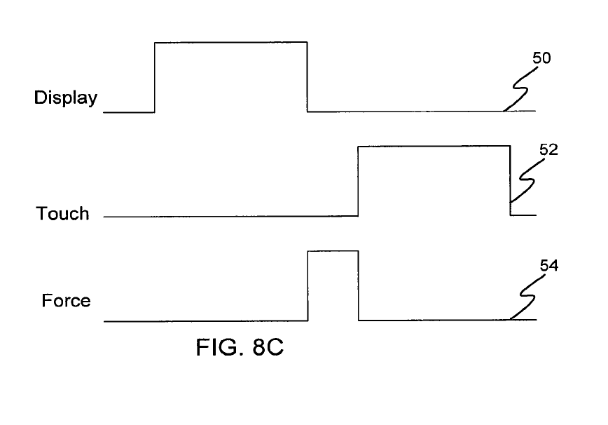

In some embodiments various components of the computing device and/or touch screen device may be driven or activated separately from each other and/or on separate frequencies. Separate drive times and/or frequencies for certain components, such as the display, touch sensor or sensors (if any), and/or force sensors may help to reduce cross-talk and noise in various components. FIGS. 8A-8C illustrate different timing diagram examples, each will be discussed in turn below. It should be noted that the timing diagrams discussed herein are meant as illustrative only and many other timing diagrams and driving schemes are envisioned.

With respect to FIG. 8A, in some embodiments, the display 14 and the force sensor 18 may be driven substantially simultaneously, with the touch sensitive component 1001 being driven separately. In other words, the driver circuits for the force sensing device 18 may be activated during a time period that the display is also activated. For example, the display signal 30 and the force sensing signal 34 may both be on during a first time period and then may both inactive as the touch sensing device signal 32 is activated.

With respect to FIG. 8B, in some embodiments, the touch and force devices may be driven at substantially the same time and the display may be driven separately. For example, the display signal 40 may be set high (e.g., active) during a time that the touch signal 42 and the force signal 44 may both be low (e.g., inactive), and the display signal 40 may be low while both the touch signal 42 and the force signal 44 are high. In this example, the touch signal 42 and the force signal 44 may have different frequencies. In particular, the touch signal 42 may have

a first frequency F1 and the force signal 44 may have a second frequency F2. By utilizing separate frequencies F1 and F2, the computing device may be able to sample both touch inputs and force inputs at substantially the same time without one interfering with the other, which in turn may allow the processor to better correlate the touch inputs and the force inputs. In other words, the processor may be able to correlate a force input to a touch input because the sensors may be sampling at substantially the same time as one another. Additionally, the separate frequencies may reduce noise and cross-talk between the two sensors. Although the example in FIG. 8B is discussed with respect to the force and touch signals, in other embodiments each of the drive signal, the touch signal, and/or the force signal may have separate frequencies from each other and may be activated simultaneously or correspondingly with another signal.

With respect to FIG. 8C, in some embodiments, various components in the computing device may be driven separately from one another. For example, the display signal 50 may be driven high, while both the touch signal 52 and the force signal 54 are low. Additionally, the touch signal 52 may be high while both the force signal 54 and the display signal 50 are low and similarly the force signal 54 may be high while both the display signal 50 and the touch signal 52 are low. In these examples, the force signal's active period may be positioned between the active periods of the display and the touch sensor. In other words, the force sensor 18 may be driven between the display being driven and the touch sensors being driven. In these examples, each of the devices may be active at separate times from one another, thereby reducing inter-system noise. In some embodiments, the force sensor may have a shorter drive time than the display or touch signals; however, in other embodiments, the force sensor may have a drive time that is substantially the same as or longer than the display and/or touch sensor.

### Alternative Embodiments

The techniques for performing ultrasound-based force sensing, particularly in a touch device, and using information gleaned from or associated with ultrasound-based force sensing to perform methods associated with touch recognition, touch elements of a GUI, and touch input or manipulation in an application program, are each responsive to, and transformative of, real-world events, and real-world data associated with those events, such as force sensing data received from a user's activity, and provides a useful and tangible result in the service of operating a touch device. The processing of ultrasound-based force sensing data by a computing device includes substantial computer control and programming, involves substantial records of ultrasound-based force sensing data, and involves interaction with ultrasound-based force sensing hardware and optionally a user interface for using ultrasound-based force sensing information.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

1. An electronic device, including:
a housing;
an electronic component at least partially surrounded by the housing and connected to the housing;
one or more force sensitive sensors positioned beneath the electronic component and providing information with respect to applied force, the information including a measure of an amount of force presented at the one or more locations on an exterior of the device at which a touch occurs; wherein
the force sensitive sensors are responsive to an ultrasonic pulse emitted through the electronic component and reflected from a surface of the device corresponding to the applied force.

2. A device as in claim 1, wherein:
the electronic component is a touch-sensitive display;
the one or more force sensitive sensors are positioned beneath the display and a corresponding display stack; and
the ultrasonic pulse is emitted through, and returns through, the display and the display stack.

3. A device as in claim 1, wherein
the one or more force sensitive sensors are responsive to a change in the applied force and a change in the location at which the contact occurs.

4. A device as in claim 1, wherein
the one or more force sensitive sensors include one or more force sensing elements, each one of the one or more force sensing elements being disposed to determine an amount of applied force at a portion of the surface of the display.

5. A device as in claim 1, wherein:
each of the force sensitive sensors comprise:
an ultrasonic pulse generator disposed to direct an ultrasonic pulse toward a portion of the surface; and
a receiver coupled to a reflection of the ultrasonic pulse from the surface and disposed to receive the reflection from the portion of the surface; and
the device further comprises a measurement element to determine an amount of applied force at the portion of the surface based on the reflection.

6. A device as in claim 2, further comprising:
an ultrasonic pulse generator disposed to direct an ultrasonic pulse through the display and display stack;
a measurement element to determine an amount of applied force at the surface;
a touch-sensing circuit operative to sense touch during a period in which the ultrasonic pulse is not traveling through the display and display stack; and wherein
each of the force sensitive circuits comprises a receiver to receive reflection of the ultrasonic pulse from the surface.

7. A device as in claim 6, wherein
the measurement element to determine a location of applied force at the surface.

8. A method for estimating a force applied to a surface, comprising:
emitting an ultrasonic pulse towards a surface and through an electronic component;
receiving a reflected ultrasonic signal from the surface, the reflected ultrasonic signal traveling through the component;
determining a difference in energy between the ultrasonic pulse and the reflected ultrasonic signal; and
estimating a force from the difference in energy.

9. The method of claim 8, further comprising the operation of employing the force as an input to a computing device.

10. The method of claim 8, wherein the reflected ultrasonic signal is at least partially reflected from the surface.

11. The method of claim 10, further comprising the operation of accounting for an attenuation of at least one of the ultrasonic pulse and the reflected ultrasonic signal prior to the operation of determining the difference in energy.

12. The method of claim 8, further comprising the operations of:
defining a temporal transmission window;
defining a temporal reception window; wherein
the operation of emitting the ultrasonic pulse towards the surface occurs only during the temporal transmission window; and
the operation of receiving the reflected ultrasonic signal from the surface occurs only during the temporal reception window.

13. The method of claim 12, wherein the temporal transmission window and the temporal reception window do not overlap.

14. The method of claim 13, wherein an end of the temporal transmission window is separated by approximately 450 nanoseconds from a beginning of the temporal reception window.

15. The method of claim 8, further comprising the operations of:
comparing the difference in energy to a prior-determined difference in energy between a prior ultrasonic pulse and a prior reflected ultrasonic signal; and
based on the comparison, determining if an object is touching the surface.

16. An apparatus for accepting a force as an input, comprising:
at least one ultrasonic emitter;
an optically transparent surface disposed above the at least one ultrasonic transmitter;
a display disposed beneath the optically transparent surface and above the at least one ultrasonic emitter;
at least one ultrasonic receiver positioned below the at least one ultrasonic emitter; and
a measurement element operative to estimate a force applied to the optically transparent surface, the estimation based on an attenuation of an ultrasonic pulse emitted from the ultrasonic emitter, reflected from the optically transparent surface and received by the ultrasonic receiver.

17. (canceled)

18. The apparatus of claim 16, wherein the optically transparent surface comprises a glass.

19. The apparatus of claim 16, wherein the at least one ultrasonic emitter comprises a piezoelectric film.

20. The apparatus of claim 16, further comprising a processor operatively connected to the at least one ultrasonic receiver and configured to estimate a force exerted on the optically transparent surface based on a signal received by the at least one ultrasonic receiver.
